(19) United States
(12) Patent Application Publication
(10) Pub. No.: US 2025/0286657 A1
(43) Pub. Date: Sep. 11, 2025

(54) CONFIGURING A CODEBLOCK SIZE BASED ON DEVICE CAPABILITY

(71) Applicant: QUALCOMM Incorporated, San Diego, CA (US)

(72) Inventors: Ashutosh Vinod AGRAWAL, Bengaluru (IN); Murali KOLLENGODE RAMACHANDRAN, Bangalore (IN); Harsha ACHARYA, Santa Clara, CA (US); Shashidhar VUMMINTALA, Bangalore (IN); Alessandro RISSO, San Diego, CA (US); Tiben CHE, San Diego, CA (US); Jaeyoung KWAK, San Jose, CA (US)

(21) Appl. No.: 18/597,058

(22) Filed: Mar. 6, 2024

(51) Int. Cl. H04L 1/00; H04W 8/24

(52) U.S. Cl. CPC H04L 1/0076; H04L 1/0057; H04W 8/24

(57) ABSTRACT

Various aspects of the present disclosure generally relate to wireless communication. In some aspects, a user equipment (UE) may transmit an indication of a maximum supported code block (CB) size for a data channel. The UE may process a data channel communication based at least in part on the maximum supported CB size. Numerous other aspects are described.

### FIELD OF THE DISCLOSURE

Aspects of the present disclosure generally relate to wireless communication and specifically relate to techniques, apparatuses, and methods for configuring a codeblock size based on device capability.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include transmitting an indication of a maximum supported codeblock (CB) size for a data channel. The method may include processing a data channel communication based at least in part on the maximum supported CB size.

Some aspects described herein relate to a method of wireless communication performed by a network node. The method may include receiving an indication of a maximum supported CB size for a data channel that is used by a UE. The method may include processing a data channel communication that is associated with the UE based at least in part on the maximum supported CB size.

Some aspects described herein relate to an apparatus for wireless communication at a UE. The apparatus may include one or more memories and one or more processors coupled to the one or more memories. The one or more processors may be configured to transmit an indication of a maximum supported CB size for a data channel. The one or more processors may be configured to process a data channel communication based at least in part on the maximum supported CB size.

Some aspects described herein relate to an apparatus for wireless communication at a network node. The apparatus may include one or more memories and one or more processors coupled to the one or more memories. The one or more processors may be configured to receive an indication of a maximum supported CB size for a data channel that is used by a UE. The one or more processors may be configured to process a data channel communication that is associated with the UE based at least in part on the maximum supported CB size.

Some aspects described herein relate to a non-transitory computer-readable medium that stores a set of instructions for wireless communication by a UE. The set of instructions, when executed by one or more processors of the UE, may cause the UE to transmit an indication of a maximum supported CB size for a data channel. The set of instructions, when executed by one or more processors of the UE, may cause the UE to process a data channel communication based at least in part on the maximum supported CB size.

Some aspects described herein relate to a non-transitory computer-readable medium that stores a set of instructions for wireless communication by a network node. The set of instructions, when executed by one or more processors of the network node, may cause the network node to receive an indication of a maximum supported CB size for a data channel that is used by a UE. The set of instructions, when executed by one or more processors of the network node, may cause the network node to process a data channel communication that is associated with the UE based at least in part on the maximum supported CB size.

Some aspects described herein relate to an apparatus for wireless communication. The apparatus may include means for transmitting an indication of a maximum supported CB size for a data channel. The apparatus may include means for processing a data channel communication based at least in part on the maximum supported CB size.

Some aspects described herein relate to an apparatus for wireless communication. The apparatus may include means for receiving an indication of a maximum supported CB size for a data channel that is used by a UE. The apparatus may include means for processing a data channel communication that is associated with the UE based at least in part on the maximum supported CB size.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of a low-density parity check coding procedure, in accordance with the present disclosure.

FIG. 5 is a diagram illustrating an example of a transport block that is partitioned into one or more codeblocks (CBs), in accordance with the present disclosure.

FIGS. 6A and 6B are diagrams illustrating a first example and a second example, respectively, of a wireless communication process between a network node and a UE, in accordance with the present disclosure.

FIGS. 7A and 7B are diagrams illustrating a first example and a second example of comparisons between varying transmission block sizes and CB sizes, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A communication from a transmitting entity, such as a network node and/or a user equipment (UE), to a receiving entity, such as the UE and/or the network node, may be encoded based at least in part on an error correcting code so that the receiving entity can determine whether the communication was properly transmitted and/or verify that the communication was not corrupted. One example of an error correcting code is a low-density parity check (LDPC) code.

“LDPC coder area” may denote an amount of physical and/or logical resources of a computing device that may be used to implement an LDPC coder (e.g., an LDPC encoder and/or an LDPC decoder). Some example resources may include memory, a computational resource (e.g., a central processing unit (CPU) cycle), and/or a chip (e.g., a field programmable gate array (FPGA)). Accordingly, “LDPC coder area” may refer to a memory size, a number of CPU cycles, and/or a number of logical gates, a memory size, and/or interconnects used in a chip to implement the LDPC coder.

A variety of factors may impact a size of an LDPC coder area (e.g., an LDPC encoder area and/or an LDPC decoder area), such as a code rate, a code size, and/or a decoding algorithm. Alternatively, or additionally, a size of the LDPC coder area may be based at least in part on a base graph, as described below. Some communication standards may specify one or more parameters that configure a base graph (e.g., a code length, a code rate, a base matrix, a parity-check matrix, a sub-matrix size, a first number of columns in the parity-check matrix, and/or a second number of columns in the parity-check matrix), and a wireless communication device that supports the communication standard may perform communications using the specified base graphs. At times, the base graphs specified by a communication standard may result in an LDPC coder area that consumes a disproportionate number of resources at a wireless communication device.

To illustrate, a reduced capacity (RedCap) UE and/or an enhanced RedCap (eRedCap) UE may have less memory and/or a less powerful CPU (e.g., slower clock rate, fewer instructions per cycle, and/or smaller cache size) relative to a mobile phone UE. However, the communication standard may specify base graph parameters that are configured for the capabilities and/or operating conditions of the mobile phone UE. As one example, the communication standard may select parameters for a base graph that increase data throughput and/or decrease recovery errors for high data rates (e.g., data rates that satisfy a high throughput threshold) used by the mobile phone UE, such as by selecting parameters that are based on a large codeblock (CB) size (e.g., 8 kilobits (kb)). A RedCap UE, however, may use a low data rate (e.g., a data rate that satisfies a low throughput threshold) for the transfer of information. Based at least in part on having different needs, the RedCap UE may include different capabilities relative to the mobile phone UE as described above, and using a base graph that is specified by the communication system may result in inefficiencies in resource usage (e.g., inefficient memory consumption and/or inefficient usage of computational resources), increased computation times, and/or failed operations at the RedCap UE.

Various aspects relate generally to configuring a CB size based on device capability. Some aspects more specifically relate to a UE indicating information that results in a reduced LDPC coder area size (e.g., a reduced LDPC encoder area size and/or a reduced LDPC decoder area size), as described below. In some aspects, a UE may transmit an indication of a maximum supported CB size for a data channel. For example, a RedCap UE may transmit an indication of a maximum supported CB size that is lower than a second maximum CB size, as described below. Accordingly, the UE may process a data channel communication using the (indicated) maximum supported CB size. For example, as part of processing the data channel communication, the UE may perform LDPC decoding for a downlink data communication using an LDPC decoder and/or may perform LDPC encoding for an uplink data channel communication using an LDPC encoder. The LDPC coder area at the UE (e.g., the LDPC decoder area and/or the LDPC encoder area) may be based at least in part on the maximum supported CB size indicated by the UE and, consequently, resources available at the UE.

Particular aspects of the subject matter described in this disclosure can be implemented to realize one or more of the following potential advantages. In some examples, by indicating a maximum supported CB size, the described techniques can be used to enable a UE (e.g., a RedCap UE) to provide a network node with information that results in the UE processing communications within the capabilities of the UE. For instance, the UE may indicate a maximum supported CB size that drives a lifting size associated with an LDPC coder and/or results in an LDPC coder area that is within the capabilities of the UE and/or satisfies operating conditions at the UE (e.g., a data throughput condition). Alternatively, or additionally, indicating a maximum supported CB size may result in an LDPC coder at the UE that uses resources (e.g., memory and/or computational resources) in an efficient manner and/or does not deprive the resources to other programs at the UE. More efficient usage of resources at the UE may increase a processing performance (e.g., complete computations with less delay), reduce communication failures, decrease data transfer latencies, and/or increase data throughput at the UE.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

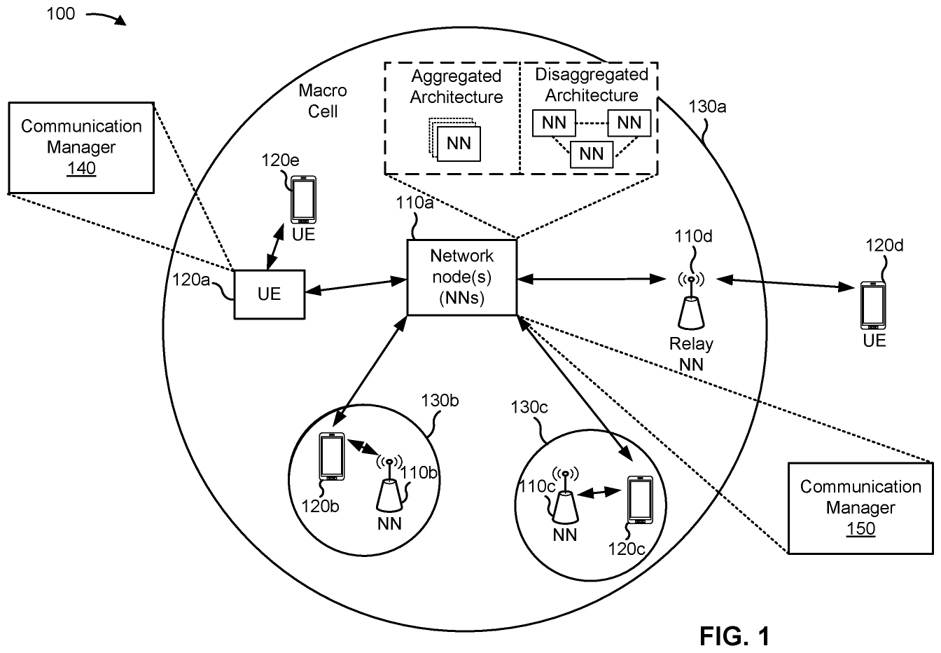

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “Sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally, or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally, or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally, or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., a UE 120) may include a communication manager 140. As described in more detail elsewhere herein, the communication manager 140 may transmit an indication of a maximum supported CB size for a data channel; and process a data channel communication based at least in part on the maximum supported CB size. Additionally, or alternatively, the communication manager 140 may perform one or more other operations described herein.

In some aspects, a network node (e.g., a network node 110) may include a communication manager 150. As described in more detail elsewhere herein, the communication manager 150 may receive an indication of a maximum supported CB size for a data channel that is used by a UE; and process a data channel communication that is associated with the UE based at least in part on the maximum supported CB size. Additionally, or alternatively, the communication manager 150 may perform one or more other operations described herein.

As indicated above, FIG. 1 is provided as an example. Other examples may differ from what is described with regard to FIG. 1.

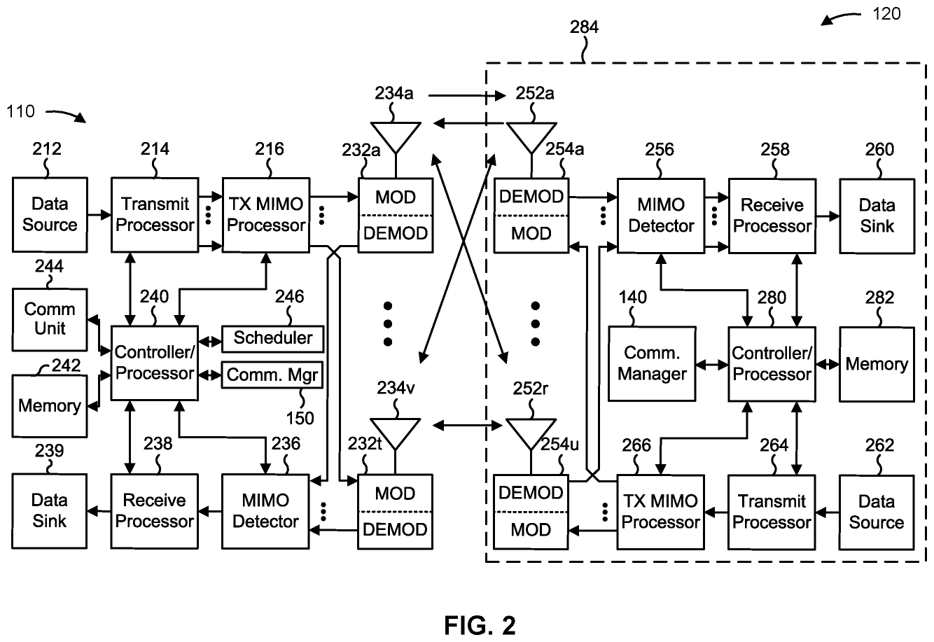

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

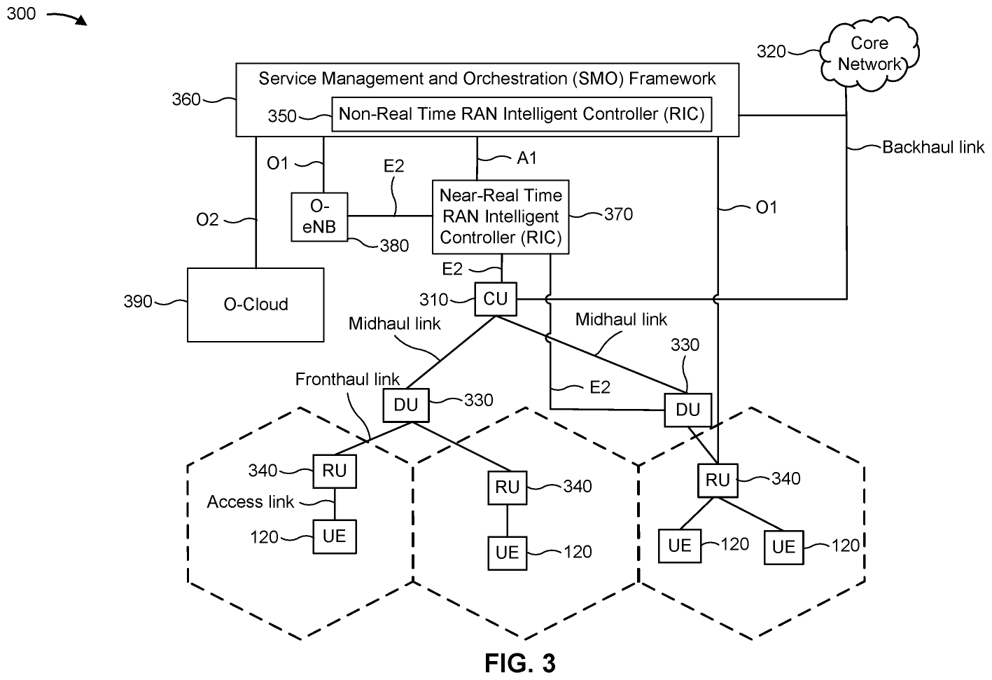

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally, or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

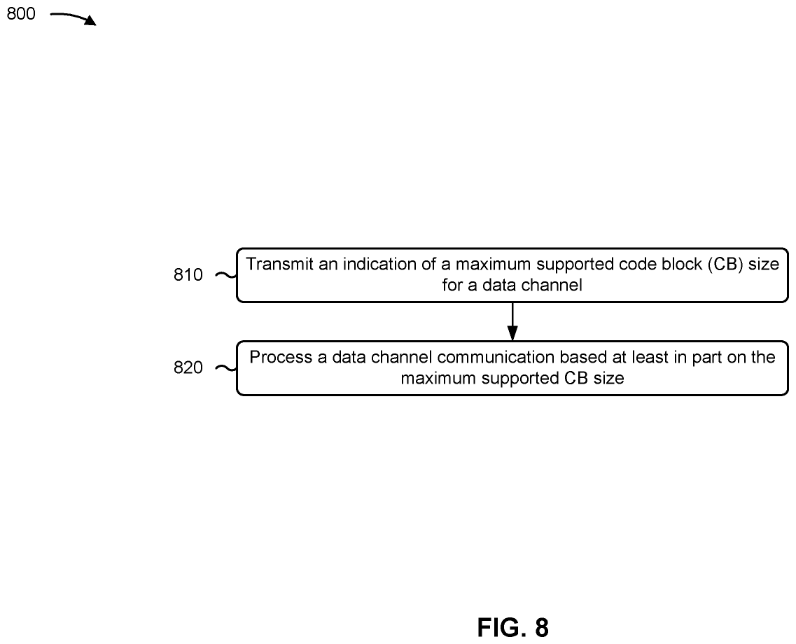

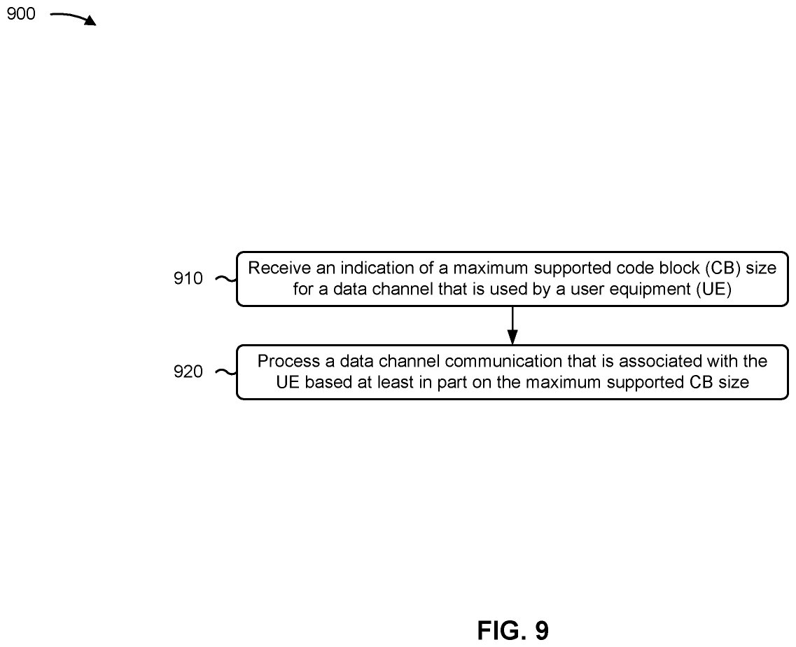

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with configuring a CB size based on device capability, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, process 900 of FIG. 9, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, a UE (e.g., a UE 120) includes means for transmitting an indication of a maximum supported CB size for a data channel; and/or means for processing a data channel communication based at least in part on the maximum supported CB size. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., a network node 110) includes means for receiving an indication of a maximum supported CB size for a data channel that is used by a UE; and/or means for processing a data channel communication that is associated with the UE based at least in part on the maximum supported CB size. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

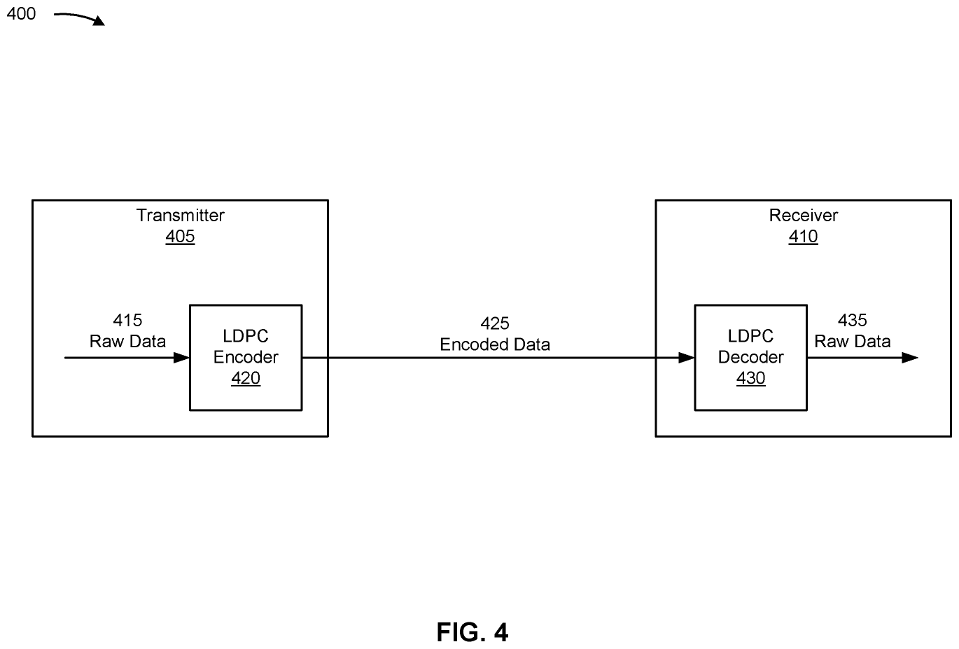

FIG. 4 is a diagram illustrating an example 400 of a low density parity check (LDPC) coding procedure, in accordance with the present disclosure.

A communication from a transmitting entity (e.g., a UE 120 or a network node 110) to a receiving entity (e.g., the network node 110, the UE 120, and/or another UE 120) may be encoded based at least in part on an error correcting code (sometimes referred to as an error correcting scheme) so that the receiving entity can determine whether the communication was properly transmitted and/or verify that the communication was not corrupted (e.g., during transmission and/or reception). Alternatively, or additionally, the error correcting code may enable the receiving entity to correct transmission errors, such as by using redundant bits provided by the error correcting code. One example of an error correcting code is an LDPC code. A communication may be encoded based at least in part on an LDPC code to provide for error detection and/or error correction at the receiving entity. Encoding for an LDPC may be performed based at least in part on a base graph that defines a structure of the LDPC code. In some aspects, the base graph may identify a codeword to be generated from an input data set and/or may identify information to be appended to an input data set to form the LDPC.

As shown in FIG. 4, a transmitter 405 may be in wireless communication with a receiver 410. In some cases, the transmitter 405 may one of a UE 120 or a network node 110, and the receiver 410 may be the other one of the UE 120 and the network node 110. The transmitter 405 and the receiver 410 may be in wireless communication via a wireless network, such as the wireless network 100 described in connection with FIG. 1. To transmit data to the receiver 410, the transmitter 405 may first encode the data using an error correcting code, such as an LDPC code. More particularly, as shown by reference number 415, the transmitter 405 may process raw data (e.g., unencoded data) to be transmitted to the receiver 410 by feeding the raw data through an LDPC encoder 420, among other signal processing components. The transmitter 405 may perform other signal processing operations (e.g., interleaving or the like), which are not shown in FIG. 4 for clarity. The LDPC encoder 420 may add error correction bits to the raw data based at least in part on a selected base graph and/or based at least in part on a target code rate, forming a stream of encoded data, as shown by reference number 425. In some aspects, “code rate” may refer to a number of raw data bits divided by a total number of bits in an encoded data stream (e.g., the code rate is the proportion of the data stream that is useful, or non-redundant). First LDPC coding (and/or similar processes) associated with a lower code rate may provide more error protection relative to second LDPC coding at a higher coding rate, at a tradeoff of the first LDPC coding using additional overhead relative to the second LDPC coding. The encoded data may be transmitted by the transmitter 405 to the receiver 410 using a RAN or the like, where the encoded data is fed through an LDPC decoder 430 (and, in some aspects, other signal processing components such as a deinterleaver) in order to extract the raw data therefrom, as shown by reference number 435. While described with regard to LDPC coding, other examples may include different encoding and/or decoding processes, such as product distribution polynomial code (PDPC) encoding and/or PDPC decoding.

“Coder area” may denote an amount of physical and/or logical resources of a computing device that may be used to implement a coder, such as an LDPC encoder, an LDPC decoder, a PDPC encoder, and/or a PDPC decoder. Some example resources may include memory, a computational resource (e.g., a central processing unit (CPU) cycle), and/or a chip (e.g., a field programmable gate array (FPGA)). Accordingly, “coder area” may refer to a memory size, a number of CPU cycles, and/or a number of logical gates, a memory size, and/or interconnects used in a chip to implement the coder (e.g., an LDPC encoder, LDPC decoder, a PDPC encoder, and/or a PDPC decoder).

A variety of factors may impact a size of a coder area (e.g., an LDPC encoder area and/or an LDPC decoder area), such as a code rate, a code size, and/or a decoding algorithm. As one example, an LDPC coder area may be based at least in part on a memory size (e.g., at least a minimum memory size) that an LDPC coder uses to store and/or check the variable node log-likelihood ratios (LLRs). To illustrate, in LDPC coding, variable nodes may represent encoded bits, and an LLR associated with a respective variable node may indicate a likelihood and/or a measure of reliability that the encoded bits associated with the respective variable node are the correct encoded bits. The use of LLR may lead to decreased recovery errors. Alternatively, or additionally, LDPC coding may use one or more check node LLRs that indicate a likelihood and/or measure of reliability for one or more parity check conditions in a parity check matrix. In some aspects, each check node may be associated with a set of signs (e.g., check node signs) that indicate whether a particular bit contributes positively or negatively to a parity check. Accordingly, the resources used by the LDPC coder (e.g., an LDPC encoder area and/or an LDPC decoder area) may be based at least in part on storage for the variable node LLRs, storage for check node LLRs, and storage for the check node signs. Alternatively, or additionally, a size of an LDPC coder area may be based at least in part on a base graph.

As described above, LDPC coding (e.g., encoding and/or decoding) may be performed based at least in part on a base graph that defines a structure of the LDPC code, and some communication standards may specify parameters(s) of base graph(s) that are to be used by a wireless communication device (e.g., a network node 110 and/or UE 120) for LDPC coding (e.g., encoding and/or decoding). To illustrate, a communication standard may specify that the device uses a first base graph (base graph 1 (BG1)) or a second base graph (base graph 2 (BG2)) based at least in part on a combination of a transport block size (TBS) and code rate. That is, the communication standard may indicate selection criteria for using BG1 and/or BG2 that is based at least in part on a TBS and a code rate. Alternatively, or additionally, the communication standard may specify a pairing between a transmission type and a base graph, such as by specifying that a wireless communication device should use BG1 to encode and/or decode control channel transmissions and/or BG2 to encode and/or decode data channel transmissions. In specifying a base graph, the communication standard may specify, for each base graph, any combination of a code length (e.g., an LDPC code length), a code rate, a base matrix, a parity-check matrix, a sub-matrix size, a first number of columns in the parity-check matrix, and/or a second number of columns in the parity-check matrix. Accordingly, a wireless communication device that supports the communication standard may perform communications using the specified base graphs, and the specified base graphs may influence a size of an LDPC coder area at the wireless communication device. For instance, for BG1, a number of variable nodes used by LDPC coding may be computed as:

$$number of variable nodes = 68 \times Zc ,$$

where Zc represents a lifting size, 68 is a number of columns in a mother code matrix (e.g., a building block) for the parity check matrix of a base graph (e.g., BG1), and a lifting size represents a number of variable nodes that are connected within a lifting structure. As another example, for BG1, a number of check nodes used by LDPC coding may be computed as:

$$number of check nodes = 46 \times Zc$$

where 46 is a number of rows in a mother code matrix for the parity check matrix of a base graph (e.g., BG1). Alternatively, or additionally, a number of check nodes used by LDPC coding may be related to a number of edges in a parity check matrix and/or a number of edges that connect the variable nodes and parity check nodes in a mother code matrix for a parity check matrix of a given base graph (e.g., BG1), and the number of edges may be computed as:

$$number of edges = 316 \times Zc$$

In some aspects, the base graphs specified by a communication standard (e.g., BG1 and BG2) may result in an LDPC coder area that consumes a disproportionate number of resources at a wireless communication device. For example, a RedCap UE and/or an enhanced RedCap (eRedCap) UE may have less memory and/or a less powerful CPU (e.g., slower clock rate, fewer instructions per cycle, and/or smaller cache size) relative to a mobile phone UE. For simplicity, discussions below refer to a RedCap UE, but may alternatively or additionally pertain to an eRedCap UE. In some aspects, the RedCap UE may have a reduced data throughput condition relative to the mobile phone UE (e.g., 10 megabits per second (Mbps) relative to 500 Mbps).

At times, the parameters specified by a communication standard for a base graph (e.g., BG1 and BG2) may be configured for the capabilities and/or operating conditions of the mobile phone UE. For instance, the communication standard may select parameters for BG1 and/or BG2 that increase data throughput and/or decrease recovery errors for high data rates. “High data rate” may denote a data rate that satisfies a high throughput threshold, such as a 500 Mbps data rate and/or a 1 Gigabits per second (Gbps) data rate. A RedCap UE, however, may use, and/or only need, information that is transmitted at a low data rate (e.g., a data rate that satisfies a low throughput threshold, such as a 10 Mbps data rate). Based at least in part on having different needs, the RedCap UE may include different capabilities relative to the mobile phone UE, and using the BG1 and/or the BG2 configured for the mobile phone UE may result in inefficiencies in resource usage (e.g., inefficient memory consumption and/or inefficient usage of computational resources), increased computation times, and/or failed operations at the RedCap UE.

To illustrate, a lifting matrix may be used in LDPC coding to connect variable nodes to check nodes, and a lifting size (e.g., Zc) of the lifting matrix may be a function of a maximum CB size. “Lifting size” may denote a scaling factor that is applied to a parity check matrix (e.g., a base parity check matrix) to scale a code block size, and “maximum CB size” may denote a maximum number of information bits (e.g., user data) that may be encoded into a single LDPC code block. In some aspects, a maximum CB size may be based at least in part on a base graph used in the LDPC coding, such as BG1 and/or BG2, as specified by a communication standard. As one non-limiting example, a maximum CB size that is associated with the use of BG1 being 8448 bits may result in a lifting size of Zc=384. Accordingly, a UE supporting a communication standard that specifies parameters of BG1 may need to include memory and/or computational resources that support performing LDPC encoding and/or decoding that is based at least in part on a maximum CB size of 8448 bits.

The use of a maximum CB size=8448 and/or Zc=384 at a RedCap UE may result in an LDPC coder area size (e.g., an LDPC encoder area size and/or an LDPC decoder area size) that consumes a majority of, if not all, memory resources and/or computational resources at the RedCap UE. Alternatively, or additionally, the RedCap UE may have insufficient memory to execute the LDPC coder. Accordingly, and based at least in part on using a base graph specified by a communication standard, the LDPC coder area size may result in inefficient memory use (e.g., increased memory overhead) at the RedCap UE. To illustrate, the RedCap UE may allocate X amount of memory to an LDPC coder area based at least in part on the lifting size and/or the maximum CB size, but may only use a fraction of the memory (e.g., less than ½X) for performing the LDPC coding. Accordingly, the smaller memory capacity and/or computational resources at the RedCap UE may result in slower processing performance at the UE (e.g., based at least in part on memory management), increased data transfer latencies (e.g., due to slower processing performance), reduced data throughput (e.g., due to slower processing performance) and/or communication failures (e.g., due to the RedCap UE not having enough memory and/or computational resources). Alternatively, or additionally, the consumption of most of the memory and/or computation resources for LDPC coding at the RedCap UE may result in less memory and/or computational resources being available for other programs at the RedCap UE. That is, the other programs may have significant delay in execution and/or may cease to function.

Some techniques and apparatuses described herein provide configuring a CB size based on device capability. In some aspects, a UE may transmit an indication of a maximum supported CB size for a data channel. For example, a RedCap UE may transmit an indication of a maximum supported CB size that is lower than a second maximum CB size associated with BG1 as described above (e.g., 8448 bits). Based at least in part on indicating the maximum supported CB size, the UE may process a data channel communication based at least in part on the maximum supported CB size. For example, as part of processing the data channel communication, the UE may use an LDPC coder (e.g., an LDPC encoder and/or an LDPC decoder), and the LDPC coder area may be based at least in part on the maximum supported CB size indicated by the UE and, consequently, resources available at the UE.

By indicating a maximum supported CB size, a UE (e.g., a RedCap UE) may provide a network node with information that enables the UE to process a communication within the capabilities of the UE. For instance, the UE may indicate a maximum supported CB size that drives a lifting size associated with an LDPC coder and/or results in an LDPC coder area that is within the capabilities of the UE and/or satisfies operating conditions at the UE (e.g., a data throughput condition). Alternatively, or additionally, indicating a maximum supported CB size may result in an LDPC coder at the UE that uses resources (e.g., memory and/or computational resources) in an efficient manner and/or does not deprive the resources to other programs at the UE. More efficient usage of resources at the UE may increase a processing performance (e.g., complete computations with less delay), reduce communication failures, decrease data transfer latencies, and/or increase data throughput at the UE.

As indicated above, FIG. 4 is provided as an example. Other examples may differ from what is described with regard to FIG. 4.

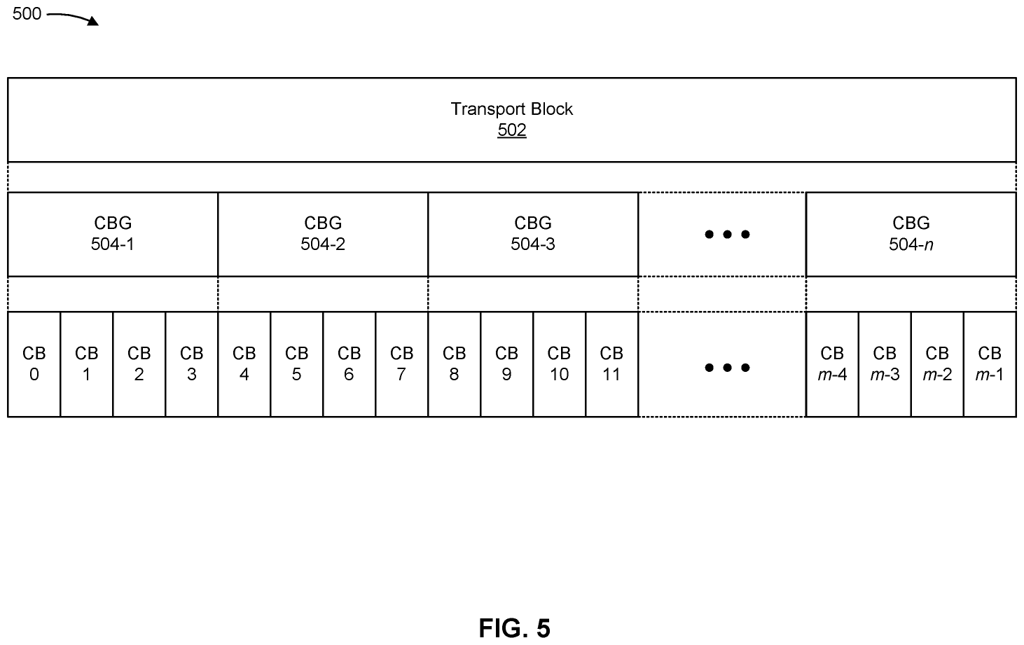

FIG. 5 is a diagram illustrating an example 500 of a transport block (TB) 502 that is partitioned into one or more code block groups (CBGs) and CBs, in accordance with the present disclosure.

Wireless communication devices (WCDs), such as a network node 110 and/or a UE 120, may include respective protocol stacks that enable a first WCD to communicate with a second WCD (and/or vice versa). A protocol stack may include multiple layers, and each layer may provide different functionality to a device. To illustrate, a UE 120 and a network node 110 may include, by way of example and not of limitation, respective PHY layers, medium access control (MAC) layers, radio link control (RLC) layers, packet data convergence protocol (PDCP) layers, and service data adaptation protocol (SDAP) layers. The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. The PHY layer may be referred to as Layer 1 (L1).

The various protocol layers may interact to enable wireless communication between the WCDs. As one example, and on a transmission side (e.g., a UE 120 transmitting an uplink communication and/or a network node 110 transmitting a downlink communication), the SDAP layer may receive a data flow and may map the data flow and/or or control information to radio bearers. Alternatively, or additionally, the SDAP layer may provide the data flows to the PDCP layer via the corresponding radio bearers. The PDCP layer may provide data, in the form of a protocol data unit (PDU), to the RLC layer via RLC channels. The RLC layer may handle transfer of upper layer PDUs to the MAC and/or PHY layers and/or may provide data, mapped to logical channels, to the MAC layer. The MAC layer may package data from logical channels into TBs, and may provide the TBs on one or more transport channels to the PHY layer. The PHY layer may handle various operations relating to transmission of a data signal, as described in more detail in connection with FIG. 2.

On the receiving side (e.g., a UE 120 receiving a downlink communication and/or a network node 110 receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer.

The TB 502 is an example TB that may be passed from the MAC layer to the PHY layer for transmission, and/or from the PHY later to the MAC layer after reception, and each TB may be configured to include a single MAC PDU. As shown by FIG. 5, a TB may be partitioned into smaller data units, such as n code block groups (CBGs) (shown by FIG. 5 as CBG 504-1, CBG 504-2, CBG 504-3, up to CBG 504-n), and each CBG may include a group of k CBs, where n and k are integers. Accordingly, the TB 502 may include m CBs, where m is an integer that may be calculated as m=n*k. Each CB may have a respective cyclic redundancy check (CRC) value that is generated by a transmitting device and/or is checked by a receiving device to identify bit errors within the CB. “Transport block size” may refer to a size of a data block that is transmitted in a communication, and “code block size (CB size)” may refer to a block of data used for error correction coding (e.g., a codeword).

In some aspects, a UE 120 may indicate a maximum supported CB size to a network node 110, and the maximum supported CB size may be based at least in part on UE resources and/or UE capabilities (e.g., a memory size and/or computational resources) that are available to implement an LDPC decoder area at the UE 120. In some aspects, the maximum supported CB size indicated by the UE 120 may satisfy a reduced capacity CB size threshold (e.g., a 1 kb threshold) and/or may be a maximum supported CB size that is specified by a communication standard for UEs that have reduced capacity (e.g., a RedCap UE maximum CB size specified by the communication standard). Alternatively, or additionally, the UE may indicate multiple maximum supported CB sizes for base graph(s) that are specified by a communication standard, such as a first maximum supported CB size for a first base graph (e.g., BG1) and a second maximum supported CB size for a second base graph (e.g., BG2).

To illustrate, as a non-limiting example, the UE may indicate a first maximum supported CB size of 528 for LDPC coding that uses BG1 and/or a second maximum supported CB size of 480 bits for LDPC coding that uses BG2, such as in UE capability information. Selection between using BG1 and BG2 may be based at least in part on a combination of TBS and a code rate. The first maximum supported CB size of 528 for LDPC coding that uses BG1 may result in a maximum lifting size of: Zmax=24 at an LDPC coder (e.g., an LDPC encoder and/or an LDPC decoder), and the second maximum supported CB size of 480 bits for LDPC coding that uses BG2 may result in a maximum lifting size of Zmax=60 at the LDPC coder, where Zmax represents the maximum lifting size. However, a lifting size Zc that is used by an LDPC coder may vary from Zmax based at least in part on TBS and/or a code rate. As one example, for a scenario that includes a maximum CB size of 480 for BG2, a TBS (with the inclusion of cyclic redundancy check (CRC) bits) that includes a number of bits B that ranges between 384 bits and 480 bits (i.e., 384≤B≤480) (where B is a number of bits in an input sequence plus a number of parity bits), an LDPC decoder may use, as Zc, a value that ranges between 48 and 60. In some aspects, for a TBS that is outside of the above indicated range, the LDPC decoder may use a maximum lifting value of 48. A larger maximum CB size for BG2 than the example of 480 may result in a Zc with a larger value as well. Accordingly, indicating maximum supported CB size(s) that satisfy the reduced capacity CB size threshold may enable a reduced capacity device (e.g., a RedCap UE and/or an eRedCap UE) to implement an LDPC decoder that uses base graphs specified by a communication standard, such as BG1 and BG2, using fewer resources for a first LDPC decoder area relative to resources used to implement a second LDPC decoder area that is not based on the maximum supported CB size.

As an example, for a scenario that includes a first maximum CB size of 1056 bits for BG1 (and/or a second maximum CB size of 480 bits for BG2), and based at least in part on using a maximum supported CB size that satisfies the reduced capacity CB size threshold and BG1, LDPC coding (e.g., encoding and/or decoding) may support coding 10 CBs in a TB for an operating configuration that includes a 10 Mbps data rate at 15 kilohertz (kHz) sub-carrier spacing (SCS). Comparatively, using a larger CB size for the operating condition may result in 2 CBs in the TB and, consequently, a larger LDPC coder area. As another example, based at least in part on using a maximum supported CB size that satisfies the reduced capacity CB size threshold and BG2, the LDPC coding may support coding 21 CBs in a TB for the same operating condition, while using a larger CB size for the operating condition may result in 3 CBs in the TB. Accordingly, indicating an upper bound for a CB size (e.g., a maximum supported CB size) may result in smaller CB sizes, and, consequently, a smaller LDPC coder area. That is, by indicating a maximum supported CB size, the UE may provide the network node with information that results in the network node selecting a communication configuration that balances an LDPC coder area with data throughput, such as a reduced LDPC decoder area and/or LDPC encoder area in combination with a reduced data throughput of 10 Mbps.

In some aspects, a communication standard may specify a range of values that may be used to indicate a maximum supported CB size. By the communication standard specifying a range of values, each UE may select a maximum supported CB size that optimizes the balance between data throughput and resource consumption by an LDPC coder based at least in part on the respective capabilities of the UE. As one non-limiting example, the communication standard may specify a first range of values and/or increments in the values for a maximum supported CB size for LDPC coding that uses BG1: X∈{528:22:8448}. Here, X represents the maximum supported CB size for LDPC coding that uses BG1 (e.g., a BG1 maximum CB size), the range of values spans 528 bits to 8448 bits, and acceptable values for X, as specified by the communication standard, may be selected from the range of values in increments of 22. Alternatively, or additionally, the communication standard may specify a second range of values and/or increments in the values for a maximum supported CB size for LDPC coding that uses BG2: Y∈{480:10:3824}. In this example, Y represents the maximum supported CB size for LDPC coding that uses BG2 (e.g., a BG2 maximum CB size), the range of values spans 480 bits to 3824 bits, and acceptable values for Y, as specified by the communication standard, may be selected from the range of values in increments of 10. However, other ranges of values and/or other increments may be used by a communication standard to specify one or more valid values for a maximum supported CB size in other examples.

To perform LDPC coding (e.g., LDPC encoding and/or LDPC decoding), a wireless communication device (e.g., a network node 110 and/or a UE 120) may calculate a maximum Zc (e.g., Zmax) using the indicated maximum supported CB sizes (e.g., the BG1 maximum size and/or the BG2 maximum size). Alternatively, or additionally, the wireless communication device may calculate a Zc that is less than Zmax using a transmission CB size that is less than an indicated maximum supported CB size. In some aspects, the wireless communication device may evaluate a block size and/or a code rate of an LDPC code, may evaluate a respective performance of various lifting sizes (e.g., a decoding latency and/or an error correction performance), may evaluate a computational complexity of LDPC coding based on a variety of lifting sizes (e.g., a memory size and/or an amount of computational resources), may select a lifting size based on balancing performance versus computational complexity, and/or may select a lifting size based at least in part on a quality of service (QOS) condition. The selected lifting size (e.g., Zmax) may be used to encode and/or decode an uplink communication and/or a downlink communication. Alternatively, or additionally, the wireless communication device may select a code rate regime by evaluating any combination of error correction capabilities, spectral efficiency, and/or data transfer latency. In some aspects, the wireless communication device may select a CRC size based at least in part on evaluating any combination of error detection operating conditions, channel characteristics, overhead size, recovery reliability, and/or efficiency (e.g., resource consumption). At times, the wireless communication device may select a code block segmentation configuration (e.g., a partitioning of data into smaller code block sizes) based at least in part on evaluating any combination of channel coding operating conditions, channel characteristics, data transfer latency operating conditions, hybrid automatic repeat request (HARQ) operating conditions, and/or dynamic adaptation that is based at least in part on a network traffic load and/or channel conditions. Alternatively, or additionally, the wireless communication device may select a rate matching configuration based at least in part on evaluating any combination of a modulation coding scheme (MCS), a system overhead size, and/or error correction capabilities.

In some aspects, and based at least in part on a UE indicating a maximum supported CB size, a device (e.g., a network node 110 and/or a UE 120) may calculate a TBS to ensure byte aligned CB sizes. The use of byte aligned CB sizes may ensure efficient data storage in memory and/or may mitigate processing partial bytes (e.g., while reading from, and/or writing to, the memory). As one example, in the calculation of TBS, N_{info} may represent an intermediate number of information bits (e.g., a number of information bits per codeword and/or per data block, and N′_{info} may represent a quantized intermediate number of information bits (e.g., a number of information bits after quantization and/or a rounding operation).

Based at least in part on N_{info}≤3824, the device may perform the following calculations to derive a TBS and/or a number of CBs using codeblock segmentation:

```
${N}_{info}^{′} = max ( 24 , {2}^{n} \cdot ⌊ \frac{{N}_{info}}{{2}^{n}} ⌋ ) , where n = max ( 3 , ⌊ {log}_{2} ( {N}_{info} ) ⌋ - 6 ) .$
If (code_rate < 0.67)
  if N′_{info} > Y
    $C = ⌈ \frac{{N}_{info}^{′} + 16}{Y - 24} ⌉$
  else
    C = 1
Else
  if N′_{info} > X
    $C = ⌈ \frac{{N}_{info}^{′} + 16}{X - 24} ⌉$
  else
    C = 1
$T B S = 8 \cdot C \cdot ⌈ \frac{{N}_{info}^{′} + 16}{8 \cdot C} ⌉ - 16 ,$
```

where X represents a first maximum supported CB size (e.g., for LDPC decoding that uses BG1), Y represents a second maximum supported CB size (e.g., for LDPC decoding that uses BG2), and C represents a number of code blocks.

Based at least in part on N_{info}>3824, the device may perform the following calculations to derive a TBS:

$${N}_{info}^{′} = max ( 3840 , {2}^{n} \times round ( \frac{{N}_{info} - 24}{{2}^{n}} ) ) ,$$

where n=└log₂(N_{info}−24)┘−5 and ties in the round function are broken toward the next largest integer.

```
if R ≤ 1/4
  if N′_{info} > Y
    $TBS = 8 \cdot C \cdot ⌈ \frac{{N}_{info}^{′} + 24}{8 \cdot C} ⌉ - 24 , where C = ⌈ \frac{{N}_{info}^{′} + 24}{Y - 24} ⌉$
  else
    $TBS = 8 \cdot ⌈ \frac{{N}_{info}^{′} + 24}{8} ⌉ - 24$
  end if
else
  if N′_{info} > X
    $TBS = 8 \cdot C \cdot ⌈ \frac{{N}_{info}^{′} + 24}{8 \cdot C} ⌉ - 24 , where C = ⌈ \frac{{N}_{info}^{′} + 24}{X - 24} ⌉$
  else
    $TBS = 8 \cdot ⌈ \frac{{N}_{info}^{′} + 24}{8} ⌉ - 24$
  end if
end if
```

where X represents a first maximum supported CB size (e.g., for LDPC decoding that uses BG1), Y represents a second maximum supported CB size (e.g., for LDPC decoding that uses BG2), C represents a number of code blocks, and R represents a code rate.

By indicating a maximum supported CB size, a UE may provide a network node with information that enables the UE to process a communication within the capabilities of the UE. Alternatively, or additionally, indicating a maximum supported CB size may result in an LDPC coder at the UE that uses resources (e.g., memory and/or computational resources) in an efficient manner and/or does not deprive the resources to other programs at the UE. More efficient usage of resources at the UE may increase a processing performance (e.g., complete computations with less delay), reduce communication failures, decrease data transfer latencies, and/or increase data throughput at the UE.

As indicated above, FIG. 5 is provided as an example. Other examples may differ from what is described with regard to FIG. 5.

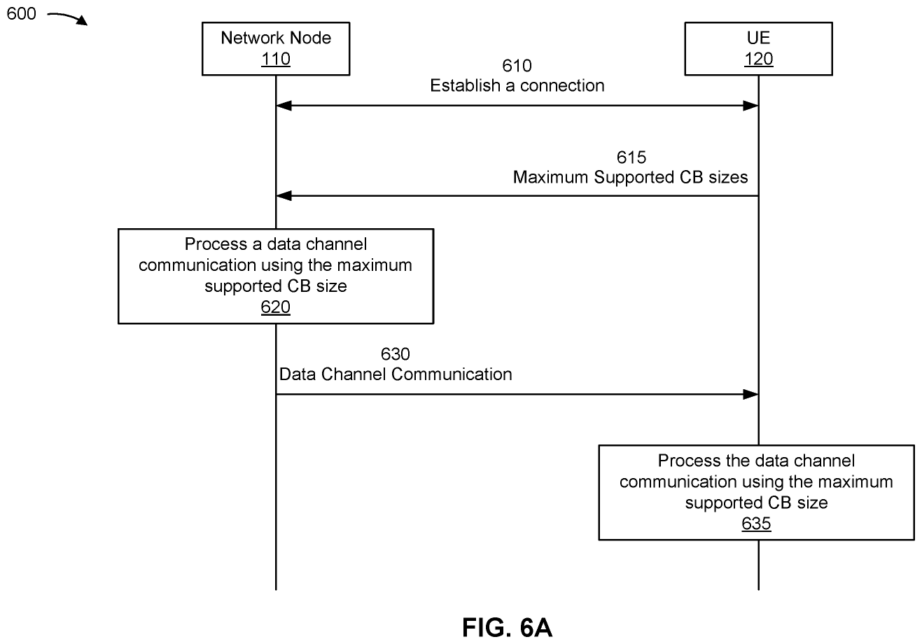

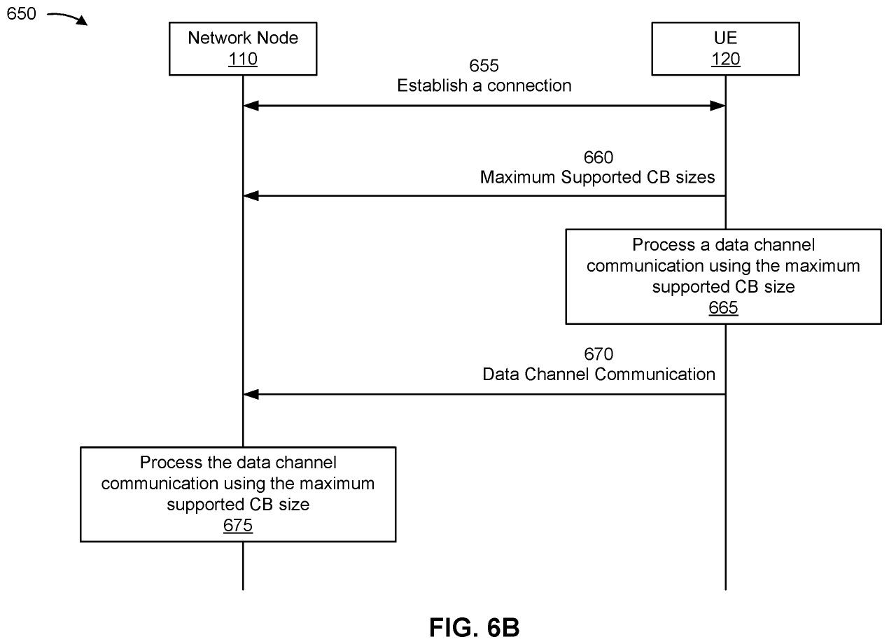

FIGS. 6A and 6B are diagrams illustrating a first example 600 and a second example 650, respectively, of a wireless communication process between a network node (e.g., the network node 110) and a UE (e.g., the UE 120), in accordance with the present disclosure. Aspects of the first example 600 may be used in combination with aspects of the second example 650.

The example 600 shown by FIG. 6A illustrates an example of a downlink data channel communication that may be processed based at least in part on a coder area, such as an LDPC encoder area at the network node 110 and/or an LDPC decoder area at the UE 120. As shown by reference number 610 in FIG. 6A, a network node 110 and a UE 120 may establish a connection. To illustrate, the UE 120 may power up in a cell coverage area provided by the network node 110, and the UE 120 and the network node 110 may perform one or more procedures (e.g., a random access channel (RACH) procedure and/or an RRC procedure) to establish a wireless connection. As another example, the UE 120 may move into the cell coverage area provided by the network node 110 and may perform a handover from a source network node (e.g., another network node 110) to the network node 110. Alternatively, or additionally, the network node 110 and the UE 120 may communicate via the connection based at least in part on any combination of Layer 1 signaling (e.g., downlink control information (DCI) and/or uplink control information (UCI)), Layer 2 signaling (e.g., a MAC control element (CE)), and/or Layer 3 signaling (e.g., RRC signaling). To illustrate, the network node 110 may request, via RRC signaling, UE capability information and/or the UE 120 may transmit, via RRC signaling, the UE capability information. As part of communicating via the connection, the network node 110 may transmit configuration information via Layer 3 signaling (e.g., RRC signaling), and activate and/or deactivate a particular configuration via Layer 2 signaling (e.g., a MAC CE) and/or Layer 1 signaling (e.g., DCI). To illustrate, the network node 110 may transmit the configuration information via Layer 3 signaling at a first point in time associated with the UE being tolerant of communication delays, and the network node 110 may transmit an activation of the configuration via Layer 2 signaling and/or Layer 1 signaling at a second point in time associated with the UE being intolerant to communication delays.

As shown by reference number 615, the UE 120 may transmit, and the network node 110 may receive, an indication of one or more maximum supported CB sizes, such as by indicating a first maximum supported CB size that is associated with LDPC decoding that uses BG1 (e.g., a BG1 maximum CB size) and/or a second maximum supported CB size that is associated with LDPC decoding that uses BG2 (e.g., a BG2 maximum CB size). For clarity, FIG. 6 illustrates the UE 120 transmitting the indication of the maximum supported CB sizes separately from establishing a connection with the network node 110. However, in other examples, the UE may transmit the indication of the maximum supported CB size(s) as part of establishing the connection, such as by transmitting an indication of the maximum supported CB size(s) in UE capability information. The UE 120 may indicate the maximum supported CB size(s) in Layer 1 signaling, Layer 2 signaling, and/or Layer 3 signaling.

In some aspects, the UE 120 may be implemented as a RedCap UE and/or an eRedCap UE. Alternatively, or additionally, the UE 120 may select the maximum supported CB size(s) based at least in part on UE capabilities and/or resources, such as a memory size and/or computational resources. As one example, the UE 120 may select the maximum supported CB size(s) from a range of values and/or increments specified by a communication standard as described with regard to FIG. 5. In some aspects, the UE may select, as the maximum supported CB sizes, one or more CB sizes that are designated for a RedCap UE. Alternatively, or additionally, the UE may select different values for the maximum supported CB sizes, such that a first base graph maximum CB size indicated by the UE 120 may be a first number of bits that is different from a second number of bits indicated by the UE for a second base graph maximum CB size. For instance, the first number of bits may be greater than the second number of bits. To illustrate, the UE may indicate a first maximum CB for BG1 (e.g., a BG1 maximum CB size) that is different from a second maximum CB for BG2 (e.g., a BG2 maximum CB size). Alternatively, or additionally, the first maximum CB size (e.g., the BG1 maximum CB size) may be associated with a higher coding rate than the second maximum CB size (e.g., the BG2 maximum CB size).

As shown by reference number 620, the network node 110 may process a data channel communication using the maximum supported CB size and/or a transmission CB size that is less that the maximum supported CB size. For example, the network node 110 may perform encoding (e.g., LDPC encoding) to generate a downlink data channel communication. In some aspects, as part of generating the data channel communications, the network node 110 may select, using the maximum supported CB size, a transmission CB size and/or a lifting size to use for encoding the data communication. Alternatively, or additionally, the maximum supported CB size used by the network node 110 may be a BG1 maximum CB size or a BG2 maximum CB size indicated by the UE 120. In some aspects, the transmission CB size may be less than the BG1 maximum CB size and/or the BG2 maximum CB size. Accordingly, the network node 100 may process the data channel communication by using the transmission CB size to generate the data channel communication as described above. As described above, at least part of processing the data channel communication may include the network node 110 encoding the data channel communication.

Alternatively, or additionally, as part of processing the data channel communication, the network node 110 may derive a TBS of the data channel communication using at least the maximum supported CB size and/or the transmission CB size selected based at least in part on the maximum supported CB size, such as by deriving the TBS using one or more calculations as described with regard to FIG. 5. Alternatively, or additionally, the network node 110 may derive the TBS using any combination of a code rate and/or a payload size. As one example, the network node 110 may calculate, based at least in part on the maximum supported CB size and/or the transmission CB size satisfying a first threshold (e.g., a small threshold), the TBS size using a first TBS selection algorithm and, based at least in part on the maximum supported CB size and/or the transmission CB size not satisfying the first threshold, may calculate the TBS size using a second TBS selection algorithm. Alternatively, the network node may calculate the TBS size based at least in part on a code rate satisfying (and/or failing to satisfy) a second threshold and/or a payload size satisfying (and/or failing to satisfy) a third threshold as described with regard to FIG. 5.

In some aspects, the network node 110 may derive a CRC size of the data channel communication based at least in part on a payload size of the data channel communication and/or may perform code block segmentation based at least in part on the TBS and/or the code rate. Alternatively, or additionally, the network node 110 may perform the code block segmentation based at least in part on the maximum supported CB size (e.g., the BG1 maximum CB size and/or the BG2 maximum CB size), the transmission CB size, and/or the TBS. As part of processing the data channel communication, the network node may perform a CRC procedure using the TBS and/or may perform a rate matching procedure for the data channel communication using the maximum supported CB size and/or the transmission CB size. In some aspects, the network node 110 may encode the data channel communication (e.g., using LDPC encoding) based at least in part on the transmission CB size.

As shown by reference number 630, the network node 110 may transmit, and the UE 120 may receive, a data channel communication. For example, the network node 110 may transmit a downlink data channel communication using a PDSCH.

As shown by reference number 635, the UE 120 may process the data channel communication using the maximum supported CB size and/or a transmission CB size that is less than that maximum supported CB size. For example, as part of processing the data channel communication, the UE 120 may perform LDPC decoding that is based at least in part on an LDPC decoding area. In some aspects, the UE 120 may select, using the maximum supported CB size, a transmission CB size and/or a lifting size to decode the data channel communication, and the maximum supported CB size used by the network node 110 may be a BG1 maximum CB size or a BG2 maximum CB size indicated by the UE 120. In some aspects, the transmission CB size may be smaller than the maximum supported CB size, and the UE 120 may decode the data channel communication using the transmission CB size.

Alternatively, or additionally, as part of processing the data channel communication, the UE 120 may derive a TBS of the data channel communication using at least the maximum supported CB size and/or the transmission CB size, such as by deriving the TBS using one or more calculations as described with regard to FIG. 5. Alternatively, or additionally, the UE 120 may drive the TBS using a code rate and/or a payload size as described with regard to FIG. 5. As one example, the UE 120 may calculate, based at least in part on the maximum supported CB size and/or the transmission CB size satisfying a first threshold (e.g., a small threshold), the TBS size using a first TBS selection algorithm and, based at least in part on the maximum supported CB size and/or transmission CB size not satisfying the first threshold, may calculate the TBS size using a second TBS selection algorithm. Alternatively, the UE 120 may calculate the TBS size based at least in part on a code rate satisfying (and/or failing to satisfy) a second threshold and/or a payload size satisfying (and/or failing to satisfy) a third threshold as described with regard to FIG. 5.

In some aspects, the UE 120 may derive a CRC size of the data channel communication based at least in part on a payload size of the data channel communication and/or may perform code block segmentation based at least in part on the TBS and/or code rate. Alternatively, or additionally, the UE may derive code block segmentation within the data channel communication based at least in part on the maximum supported CB size (e.g., the BG1 maximum CB size and/or the BG2 maximum CB size) and/or the TBS. As part of processing the data channel communication, the UE 120 may perform a CRC procedure using the TBS and/or may perform a rate matching procedure for the data channel communication using the maximum supported CB size. In some aspects, UE 120 may decode the data channel communication (e.g., using LDPC decoding) based at least in part on the transmission CB size.

The example 650 shown by FIG. 6B illustrates an example of an uplink data channel communication that may be processed based at least in part on a coder area, such as an LDPC encoder area at a UE 120 and/or an LDPC decoder area at a network node 110. As shown by reference number 655 in FIG. 6B, a network node 110 and a UE 120 may establish a connection. For instance, the network node 110 and the UE 120 may establish the connection in a similar manner as described with regard to reference number 610.

As shown by reference number 660, the UE 120 may transmit, and the network node 110 may receive, an indication of one or more maximum supported CB sizes. For instance, the UE 120 may transmit the indication in a similar manner as describe with regard to reference number 615.

As shown by reference number 665, the UE 120 may process a data channel communication using the maximum supported CB size and/or a transmission CB size that is less that the maximum supported CB size. For example, the UE 120 may perform encoding (e.g., LDPC encoding) to generate an uplink data channel communication in a similar manner as the network node 110 generating a downlink data channel communication channel as described with regard to reference number 620.

As shown by reference number 670, the UE 120 may transmit, and the network node 110 may receive, a data channel communication. For example, the UE 120 may transmit an uplink data channel communication using a PUSCH.

As shown by reference number 675, the network node 110 may process the data channel communication using the maximum supported CB size and/or a transmission CB size that is less than that maximum supported CB size. For example, as part of processing the data channel communication, the network node 110 may perform LDPC decoding that is based at least in part on an LDPC decoding area in a similar manner as the UE 120 as described with regard to reference number 635.

By indicating a maximum supported CB size, a UE may provide a network node with information that enables the UE to process a communication within the capabilities of the UE. Alternatively, or additionally, indicating a maximum supported CB size may result in an LDPC decoder at the UE that uses resources (e.g., memory and/or computational resources) in an efficient manner and/or does not deprive the resources to other programs at the UE. More efficient usage of resources at the UE may increase a processing performance (e.g., complete computations with less delay), reduce communication failures, decrease data transfer latencies, and/or increase data throughput at the UE.

As indicated above, FIGS. 6A and 6B are provided as examples. Other examples may differ from what is described with regard to FIGS. 6A and 6B.

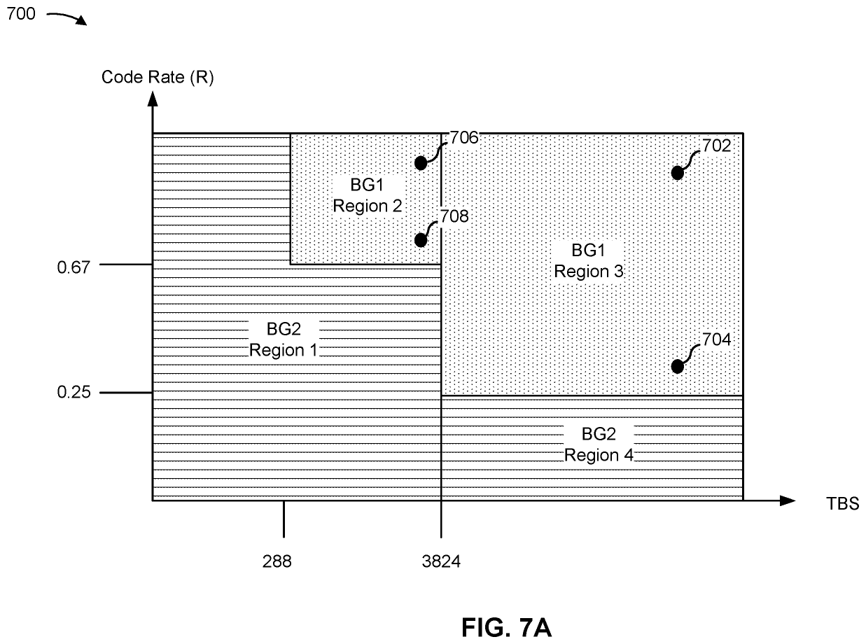

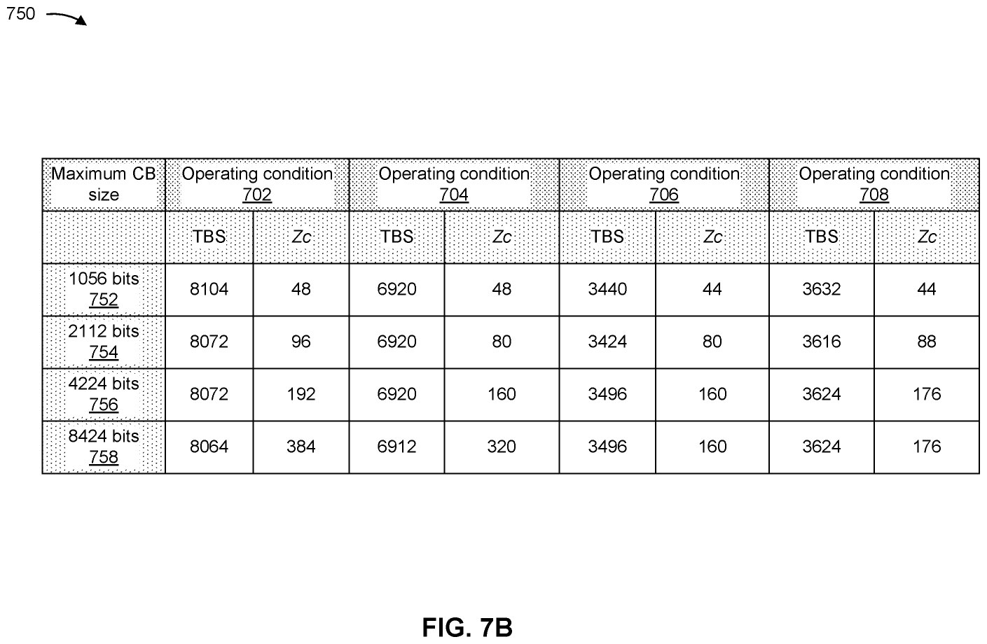

FIGS. 7A and 7B are diagrams illustrating a first example 700 and a second example 750 of comparisons between varying TB sizes and CB sizes, in accordance with the present disclosure.

The first example 700 is a base graph selection chart that provides guidance for selecting between the use of BG1 and BG2 based at least in part on a code rate (shown on a vertical axis) and a TBS (shown on a horizontal axis). The base graph selection chart has been partitioned into four regions: BG2 region 1 (shown as starting in a lower left corner of the base graph selection chart and with horizontal stripes), BG1 region 2 (shown as being in an upper, left of center position of the base graph selection chart and with a dotted pattern), BG1 region 3 (shown as being in an upper, right corner of the base graph selection chart and with a dotted pattern), and BG2 region 4 (shown as being located in a lower right corner of the base graph selection chart and with horizontal stripes). A wireless communication device may select BG1 and/or BG2 for LDPC coding using the base graph selection chart and at least a TBS and a code rate.

FIGS. 7A and 7B illustrate a comparison between different operating regions for a BG1 and/or BG2 selection, where the operating regions are based at least in part on the code rate and the TBS. The comparison described with regard to FIGS. 7A and 7B is based on the following operating conditions: 15 kHz SCS, a 20 MHz bandwidth, and a resource block (RB) allocation that is optimized to obtain a particular TBS and MCS combination. The comparison is based at least in part on four separate operating configurations: operating condition 702 that pertains to an MCS of 27, 14 RBs, and N_{info}=8062; operating condition 704 that pertains to an MCS of 4, 106 RBs, and N_{info}=6887; operating condition 706 that pertains to an MCS of 27, 6 RBs, and N_{info}=3452; and operating condition 708 that pertains to an MCS of 23, 8 RBs, and N_{info}=3628.

The second example 750 shown in FIG. 7B includes a comparison chart that is between the four operating conditions (e.g., operating condition 702, operating condition 704, operating condition 706, and operating condition 708) described with regard to FIG. 7A. More particularly, for each respective operating condition, the comparison chart is based at least in part on varying maximum supported CB sizes that may be indicated by a UE: 1056 bits in row 752, 2112 bits in row 754, 4224 bits in row 756, and 8424 bits in row 758. In some aspects, the 8424 bit comparison may be similar to an operating condition in which the UE does not indicate a maximum supported CB size to a network node. As shown in FIG. 7B, each CB size is associated with a comparable TBS, but the smaller CB sizes are associated with smaller lifting sizes (e.g., Zc), and the smaller lifting sizes may result in a smaller LDPC decoding area as described above.

As indicated above, FIGS. 7A and 7B are provided as examples. Other examples may differ from what is described with regard to FIGS. 7A and 7B.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with configuring a CB size based on device capability.

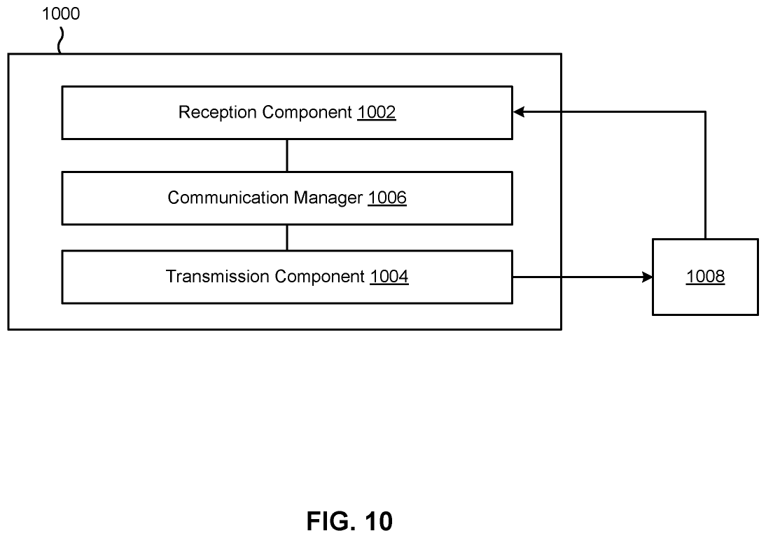

As shown in FIG. 8, in some aspects, process 800 may include transmitting an indication of a maximum supported CB size for a data channel (block 810). For example, the UE (e.g., using transmission component 1004 and/or communication manager 1006, depicted in FIG. 10) may transmit an indication of a maximum supported CB size for a data channel, as described above.

As further shown in FIG. 8, in some aspects, process 800 may include processing a data channel communication based at least in part on the maximum supported CB size (block 820). For example, the UE (e.g., using communication manager 1006, depicted in FIG. 10) may process a data channel communication based at least in part on the maximum supported CB size, as described above.

Process 800 may include additional aspects, such as any single aspect or any combination of aspects described below and/or in connection with one or more other processes described elsewhere herein.

In a first aspect, process 800 includes selecting at least one of a transmission CB size, or a lifting size, based at least in part on at least one of a BG1 maximum CB size that is based at least in part on the maximum supported CB size, or a BG2 maximum CB size that is based at least in part on the maximum supported CB size, and processing the data channel communication includes processing the data channel communication using the at least one of the transmission CB size or the lifting size.

In a second aspect, the BG1 maximum CB size is a first number of bits, the BG2 maximum CB size is a second number of bits, and the first number of bits is greater than the second number of bits.

In a third aspect, processing the data channel communication includes at least one of encoding the data channel communication using the transmission CB size, or decoding the data channel communication using the transmission CB size.

In a fourth aspect, processing the data channel communication includes deriving a TBS of the data channel communication using at least the maximum supported CB size.

In a fifth aspect, processing the data channel communication includes deriving a CRC size of the data channel communication based at least in part on a payload size of the data channel communication.

In a sixth aspect, deriving the TBS includes calculating, based at least in part on the maximum supported CB size satisfying a small threshold, the TBS size using a first TBS selection algorithm, or calculating, based at least in part on the maximum supported CB size not satisfying the small threshold, the TBS size using a second TBS selection algorithm.

In a seventh aspect, processing the data channel communication includes performing code block segmentation based at least in part on at least one of the BG1 maximum CB size, or the BG2 maximum CB size.

In an eighth aspect, processing the data channel communication includes performing a cyclic redundancy check procedure based at least in part on the TBS.

In a ninth aspect, processing the data channel communication includes performing a rate matching procedure for the data channel communication based at least in part on the maximum supported CB size.

In a tenth aspect, transmitting the indication of the maximum supported CB size is based at least in part on the UE being at least one of a RedCap device, or an eRedCap device.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with configuring a CB size based on device capability.

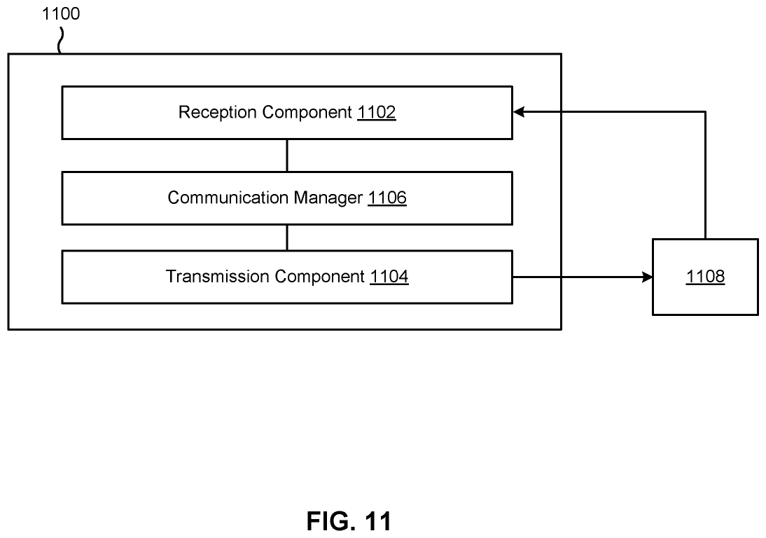

As shown in FIG. 9, in some aspects, process 900 may include receiving an indication of a maximum supported CB size for a data channel that is used by a UE (block 910). For example, the network node (e.g., using reception component 1102 and/or communication manager 1106, depicted in FIG. 11) may receive an indication of a maximum supported CB size for a data channel that is used by a UE, as described above.

As further shown in FIG. 9, in some aspects, process 900 may include processing a data channel communication that is associated with the UE based at least in part on the maximum supported CB size (block 920). For example, the network node (e.g., using communication manager 1106, depicted in FIG. 11) may process a data channel communication that is associated with the UE based at least in part on the maximum supported CB size, as described above.

Process 900 may include additional aspects, such as any single aspect or any combination of aspects described below and/or in connection with one or more other processes described elsewhere herein.

In a first aspect, process 900 includes selecting at least one of a transmission CB size, or a lifting size, based at least in part on at least one of a BG1 maximum CB size that is based at least in part on the maximum supported CB size, or a BG2 maximum CB size that is based at least in part on the maximum supported CB size, and processing the data channel communication includes processing the data channel communication using the at least one of the transmission CB size or the lifting size.

In a second aspect, the BG1 maximum CB size is a first number of bits, the BG2 maximum CB size is a second number of bits, and the first number of bits is greater than the second number of bits.

In a third aspect, processing the data channel communication includes at least one of encoding the data channel communication using the transmission CB size, or decoding the data channel communication using the transmission CB size.

In a fourth aspect, processing the data channel communication includes deriving a TBS of the data channel communication using at least the maximum supported CB size.

In a fifth aspect, processing the data channel communication includes deriving a CRC size of the data channel communication based at least in part on a payload size of the data channel communication.

In a sixth aspect, deriving the TBS includes calculating, based at least in part on the maximum supported CB size satisfying a small threshold, the TBS using a first TBS selection algorithm, or calculating, based at least in part on the maximum supported CB size not satisfying the small threshold, the TBS using a second TBS selection algorithm.

In a seventh aspect, processing the data channel communication includes performing code block segmentation based at least in part on the TBS.

In an eighth aspect, processing the data channel communication includes performing a cyclic redundancy check procedure based at least in part on the TBS.

In a ninth aspect, processing the data channel communication includes performing a rate matching procedure for the data channel communication based at least in part on the maximum supported CB size.

In a tenth aspect, transmitting the indication of the maximum supported CB size is based at least in part on the UE being at least one of a RedCap device, or an eRedCap device.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 4-7B. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit an indication of a maximum supported CB size for a data channel. The communication manager 1006 may process a data channel communication based at least in part on the maximum supported CB size.

In some aspects, the communication manager 1006 may select at least one of a transmission CB size, or a lifting size, based at least in part on at least one of a BG1 maximum CB size that is based at least in part on the maximum supported CB size, or a BG2 maximum CB size that is based at least in part on the maximum supported CB size, and processing the data channel communication includes processing the data channel communication using the transmission CB size.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4-7B. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive an indication of a maximum supported CB size for a data channel that is used by a UE. The communication manager 1106 may process a data channel communication that is associated with the UE based at least in part on the maximum supported CB size.

The communication manager 1106 may select at least one of a transmission CB size, or a lifting size. In some aspects, the communication manager 1106 may select the transmission CB size and/or the lifting size based at least in part on at least one of a BG1 maximum CB size that is based at least in part on the maximum supported CB size, or a BG2 maximum CB size that is based at least in part on the maximum supported CB size, and processing the data channel communication includes processing the data channel communication using at least one of the transmission CB size or the lifting size.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: transmitting an indication of a maximum supported code block (CB) size for a data channel; and processing a data channel communication based at least in part on the maximum supported CB size.

Aspect 2: The method of Aspect 1, further comprising: selecting at least one of: a transmission CB size, or a lifting size, based at least in part on at least one of: a base graph 1 (BG1) maximum CB size that is based at least in part on the maximum supported CB size, or a base graph 2 (BG2) maximum CB size that is based at least in part on the maximum supported CB size, wherein processing the data channel communication comprises: processing the data channel communication using the at least one of the transmission CB size or the lifting size.

Aspect 3: The method of Aspect 2, wherein the BG1 maximum CB size is a first number of bits, wherein the BG2 maximum CB size is a second number of bits, and wherein the first number of bits is greater than the second number of bits.

Aspect 4: The method of Aspect 2 or Aspect 3, wherein processing the data channel communication comprises at least one of: encoding the data channel communication using the transmission CB size; or decoding the data channel communication using the transmission CB size.

Aspect 5: The method of any one of Aspects 2-4, wherein processing the data channel communication comprises: deriving a transport block size (TBS) of the data channel communication using at least the maximum supported CB size.

Aspect 6: The method of Aspect 5, wherein processing the data channel communication comprises: deriving a cyclic redundancy check (CRC) size of the data channel communication based at least in part on a payload size of the data channel communication.

Aspect 7: The method of Aspect 6 or Aspect 7, wherein deriving the TBS comprises: calculating, based at least in part on the maximum supported CB size satisfying a small threshold, the TBS size using a first TBS selection algorithm; or calculating, based at least in part on the maximum supported CB size not satisfying the small threshold, the TBS size using a second TBS selection algorithm.

Aspect 8: The method of any one of Aspects 2-7, wherein processing the data channel communication comprises: performing code block segmentation based at least in part on at least one of: the BG1 maximum CB size, or the BG2 maximum CB size.

Aspect 9: The method of any one of Aspects 2-8, wherein processing the data channel communication comprises: performing a cyclic redundancy check procedure based at least in part on the TBS.

Aspect 10: The method of any one of Aspects 2-9, wherein processing the data channel communication comprises: performing a rate matching procedure for the data channel communication based at least in part on the maximum supported CB size.

Aspect 11: The method of any of Aspects 1-10, wherein transmitting the indication of the maximum supported CB size is based at least in part on the UE being at least one of: a reduced capacity (RedCap) device, or an enhanced RedCap (eRedCap) device.

Aspect 12: A method of wireless communication performed by a network node, comprising: receiving an indication of a maximum supported code block (CB) size for a data channel that is used by a user equipment (UE); and processing a data channel communication that is associated with the UE based at least in part on the maximum supported CB size.

Aspect 13: The method of Aspect 12, further comprising: selecting at least one of: a transmission CB size, or a lifting size, based at least in part on at least one of: a base graph 1 (BG1) maximum CB size that is based at least in part on the maximum supported CB size, or a base graph 2 (BG2) maximum CB size that is based at least in part on the maximum supported CB size, wherein processing the data channel communication comprises: processing the data channel communication using the at least one of the transmission CB size or the lifting size.

Aspect 14: The method of Aspect 13, wherein the BG1 maximum CB size is a first number of bits, wherein the BG2 maximum CB size is a second number of bits, and wherein the first number of bits is greater than the second number of bits.

Aspect 15: The method of Aspect 13 or Aspect 14, wherein processing the data channel communication comprises at least one of: encoding the data channel communication using the transmission CB size; or decoding the data channel communication using the transmission CB size.

Aspect 16: The method of any one of Aspects 13-15, wherein processing the data channel communication comprises: deriving a transport block size (TBS) of the data channel communication using at least the maximum supported CB size.

Aspect 17: The method of Aspect 16, wherein processing the data channel communication comprises: deriving a cyclic redundancy check (CRC) size of the data channel communication based at least in part on a payload size of the data channel communication.

Aspect 18: The method of Aspect 17, wherein deriving the TBS comprises: calculating, based at least in part on the maximum supported CB size satisfying a small threshold, the TBS using a first TBS selection algorithm; or calculating, based at least in part on the maximum supported CB size not satisfying the small threshold, the TBS using a second TBS selection algorithm.

Aspect 19: The method of any one of Aspects 13-18, wherein processing the data channel communication comprises: performing code block segmentation based at least in part on the TBS.

Aspect 20: The method of any one of Aspects 13-20, wherein processing the data channel communication comprises: performing a cyclic redundancy check procedure based at least in part on the TBS.

Aspect 21: The method of any one of Aspects 13-20, wherein processing the data channel communication comprises: performing a rate matching procedure for the data channel communication based at least in part on the maximum supported CB size.

Aspect 22: The method of any of Aspects 12-21, wherein transmitting the indication of the maximum supported CB size is based at least in part on the UE being at least one of: a reduced capacity (RedCap) device, or an enhanced RedCap (eRedCap) device.

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-11.

Aspect 24: An apparatus for wireless communication at a device, the apparatus comprising one or more memories and one or more processors coupled to the one or more memories, the one or more processors configured to cause the device to perform the method of one or more of Aspects 1-11.

Aspect 25: An apparatus for wireless communication, the apparatus comprising at least one means for performing the method of one or more of Aspects 1-11.

Aspect 26: A non-transitory computer-readable medium storing code for wireless communication, the code comprising instructions executable by one or more processors to perform the method of one or more of Aspects 1-11.

Aspect 27: A non-transitory computer-readable medium storing a set of instructions for wireless communication, the set of instructions comprising one or more instructions that, when executed by one or more processors of a device, cause the device to perform the method of one or more of Aspects 1-11.

Aspect 28: A device for wireless communication, the device comprising a processing system that includes one or more processors and one or more memories coupled with the one or more processors, the processing system configured to cause the device to perform the method of one or more of Aspects 1-11.

Aspect 29: An apparatus for wireless communication at a device, the apparatus comprising one or more memories and one or more processors coupled to the one or more memories, the one or more processors individually or collectively configured to cause the device to perform the method of one or more of Aspects 1-11.

Aspect 30: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 12-22.

Aspect 31: An apparatus for wireless communication at a device, the apparatus comprising one or more memories and one or more processors coupled to the one or more memories, the one or more processors configured to cause the device to perform the method of one or more of Aspects 12-22.

Aspect 32: An apparatus for wireless communication, the apparatus comprising at least one means for performing the method of one or more of Aspects 12-22.

Aspect 33: A non-transitory computer-readable medium storing code for wireless communication, the code comprising instructions executable by one or more processors to perform the method of one or more of Aspects 12-22.

Aspect 34: A non-transitory computer-readable medium storing a set of instructions for wireless communication, the set of instructions comprising one or more instructions that, when executed by one or more processors of a device, cause the device to perform the method of one or more of Aspects 12-22.

Aspect 35: A device for wireless communication, the device comprising a processing system that includes one or more processors and one or more memories coupled with the one or more processors, the processing system configured to cause the device to perform the method of one or more of Aspects 12-22.

Aspect 36: An apparatus for wireless communication at a device, the apparatus comprising one or more memories and one or more processors coupled to the one or more memories, the one or more processors individually or collectively configured to cause the device to perform the method of one or more of Aspects 12-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
transmit an indication of a maximum supported code block (CB) size for a data channel; and
process a data channel communication based at least in part on the maximum supported CB size.

2. The apparatus of claim 1, wherein the one or more processors are further configured to cause the UE to:
select at least one of:
a transmission CB size, or
a lifting size,
base at least in part on at least one of:
a base graph 1 (BG1) maximum CB size that is based at least in part on the maximum supported CB size, or
a base graph 2 (BG2) maximum CB size that is based at least in part on the maximum supported CB size,
wherein the one or more processors, to cause the UE to process the data channel communication, are configured to cause the UE to:
process the data channel communication using the at least one of the transmission CB size or the lifting size.

3. The apparatus of claim 2, wherein the BG1 maximum CB size is a first number of bits,
wherein the BG2 maximum CB size is a second number of bits, and
wherein the first number of bits is greater than the second number of bits.

4. The apparatus of claim 2, wherein the one or more processors, to cause the UE to process the data channel communication, are configured to cause the UE to:
encode the data channel communication using the transmission CB size; or
decode the data channel communication using the transmission CB size.

5. The apparatus of claim 2, wherein the one or more processors, to cause the UE to process the data channel communication, are configured to cause the UE to:
derive a transport block size (TBS) of the data channel communication using at least the maximum supported CB size.

6. The apparatus of claim 5, wherein the one or more processors, to cause the UE to process the data channel communication, are configured to cause the UE to:
derive a cyclic redundancy check (CRC) size of the data channel communication based at least in part on a payload size of the data channel communication.

7. The apparatus of claim 6, wherein the one or more processors, to cause the UE to derive the TBS, are configured to cause the UE to:
calculate, based at least in part on the maximum supported CB size satisfying a small threshold, the TBS size using a first TBS selection algorithm; or
calculate, based at least in part on the maximum supported CB size not satisfying the small threshold, the TBS size using a second TBS selection algorithm.

8. An apparatus for wireless communication at a network node, comprising:
one or more memories; and
one or more processors, coupled to the one or more memories, configured to cause the network node to:
receive an indication of a maximum supported code block (CB) size for a data channel that is used by a user equipment (UE); and
process a data channel communication that is associated with the UE based at least in part on the maximum supported CB size.

9. The apparatus of claim 8, wherein the one or more processors are further configured to cause the network node to:
select at least one of:
a transmission CB size, or
a lifting size,
base at least in part on at least one of:
a base graph 1 (BG1) maximum CB size that is based at least in part on the maximum supported CB size, or
a base graph 2 (BG2) maximum CB size that is based at least in part on the maximum supported CB size,
wherein the one or more processors, to cause the network node to process the data channel communication, are configured to cause the network node to:
process the data channel communication using the at least one of the transmission CB size or the lifting size.

10. The apparatus of claim 9, wherein the BG1 maximum CB size is a first number of bits,
wherein the BG2 maximum CB size is a second number of bits, and
wherein the first number of bits is greater than the second number of bits.

11. The apparatus of claim 9, wherein the one or more processors, to cause the network node to process the data channel communication, are configured to cause the network node to:
encode the data channel communication using the transmission CB size; or
decode the data channel communication using the transmission CB size.

12. The apparatus of claim 9, wherein the one or more processors, to cause the network node to process the data channel communication, are configured to cause the network node to:
derive a transport block size (TBS) of the data channel communication using at least the maximum supported CB size.

13. The apparatus of claim 12, wherein the one or more processors, to cause the network node to process the data channel communication, are configured to cause the network node to:
derive a cyclic redundancy check (CRC) size of the data channel communication based at least in part on a payload size of the data channel communication.

14. The apparatus of claim 13, wherein the one or more processors, to cause the network node to derive the TBS, are configured to cause the network node to:
calculate, based at least in part on the maximum supported CB size satisfying a small threshold, the TBS using a first TBS selection algorithm; or
calculate, based at least in part on the maximum supported CB size not satisfying the small threshold, the TBS using a second TBS selection algorithm.

15. A method of wireless communication performed by a user equipment (UE), comprising:
transmitting an indication of a maximum supported code block (CB) size for a data channel; and
processing a data channel communication based at least in part on the maximum supported CB size.

16. The method of claim 15, further comprising:
selecting at least one of:
a transmission CB size, or
a lifting size,
based at least in part on at least one of:
a base graph 1 (BG1) maximum CB size that is based at least in part on the maximum supported CB size, or
a base graph 2 (BG2) maximum CB size that is based at least in part on the maximum supported CB size,
wherein processing the data channel communication comprises:
processing the data channel communication using the at least one of the transmission CB size or the lifting size.

17. The method of claim 16, wherein processing the data channel communication comprises at least one of:
encoding the data channel communication using the transmission CB size; or
decoding the data channel communication using the transmission CB size.

18. The method of claim 16, wherein processing the data channel communication comprises:
deriving a transport block size (TBS) of the data channel communication using at least the maximum supported CB size.

19. The method of claim 18, wherein processing the data channel communication comprises:
deriving a cyclic redundancy check (CRC) size of the data channel communication based at least in part on a payload size of the data channel communication.

20. The method of claim 19, wherein deriving the TBS comprises:
calculating, based at least in part on the maximum supported CB size satisfying a small threshold, the TBS size using a first TBS selection algorithm; or
calculating, based at least in part on the maximum supported CB size not satisfying the small threshold, the TBS size using a second TBS selection algorithm.
